(19) United States
(12) Patent Application Publication
(10) Pub. No.: US 2013/0117218 A1
(43) Pub. Date: May 9, 2013

(54) CROSS-STORE ELECTRONIC DISCOVERY

(71) Applicants: John D. Fan, Redmond, WA (US); Adam David Harmetz, Seattle, WA (US); Sridharan Venkatramani Ramanathan, Kirkland, WA (US); Julian Zbogar-Smith, Redmond, WA (US); Thottam R. Sriram, Redmond, WA (US); Zainal Arifin, Redmond, WA (US); Anupama Janardhan, Seattle, WA (US); Ramanathan Somasundaram, Bothell, WA (US); Jessica Anne Alspaugh, Seattle, WA (US); Bradley Stevenson, Seattle, WA (US); Michal Piaseczny, Issaquah, WA (US); Quentin Christensen, Redmond, WA (US)

(72) Inventors: John D. Fan, Redmond, WA (US); Adam David Harmetz, Seattle, WA (US); Sridharan Venkatramani Ramanathan, Kirkland, WA (US); Julian Zbogar-Smith, Redmond, WA (US); Thottam R. Sriram, Redmond, WA (US); Zainal Arifin, Redmond, WA (US); Anupama Janardhan, Seattle, WA (US); Ramanathan Somasundaram, Bothell, WA (US); Jessica Anne Alspaugh, Seattle, WA (US); Bradley Stevenson, Seattle, WA (US); Michal Piaseczny, Issaquah, WA (US); Quentin Christensen, Redmond, WA (US)

(73) Assignee: MICROSOFT CORPORATION, Redmond, WA (US)

(21) Appl. No.: 13/288,903

(22) Filed: Nov. 3, 2011

(51) Int. Cl. G06F 17/00; G06F 7/00

(52) U.S. Cl. 707/603; 707/E17.001

(57) ABSTRACT

An electronic discovery (eDiscovery) application is used in managing an electronic discovery process across different electronic data sources using a central interface. The eDiscovery application assists in managing: authentication support for the different data sources; accessing the different data sources; placing holds on content across the different data sources; searching and filtering content across the different data sources; gathering data across the data sources; and the like. The eDiscovery application may be configured as an application on premise, a cloud based service and/or a combination of a cloud based service and an application.

### BACKGROUND

During a discovery phase of litigation, electronic data is often identified as being relevant to the case. This electronic data may be stored across many different data sources that each have different characteristics and authentication mechanisms. For example, one of the data sources may require a first set of authentication credentials, whereas another data sources requires different authentication credentials. Each of the data sources may also have different capabilities. For example, some data sources may include a search system as part of the service in which the data is stored whereas another data source may only include content without any inherent capability to search them (Example: a File share that contains directories with files). The identified data is often moved to a data store such that the data can be preserved and more easily managed. Accessing and managing each of these different data sources can present many challenges.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An electronic discovery (eDiscovery) application is used in managing an electronic discovery process across different electronic data sources using a central interface. The eDiscovery application assists in managing: authentication support for the different data sources; accessing the different data sources; placing holds on content across the different data sources; searching and filtering content across the different data sources; gathering data across the data sources; and the like. The eDiscovery application may be configured as an application on premises, a cloud based service and/or a combination of a cloud based service and an on premises application.

### BRIEF DESCRIPTION OF THE DRAWINGS

FIG. 1 illustrates an exemplary computing device;

FIG. 2 illustrates an exemplary eDiscovery system;

FIG. 3 shows a process for managing an eDiscovery process from a central interface that spans different data sources; and

FIG. 4 shows a process for searching and identifying data across different data sources and placing a hold on the identified data.

### DETAILED DESCRIPTION

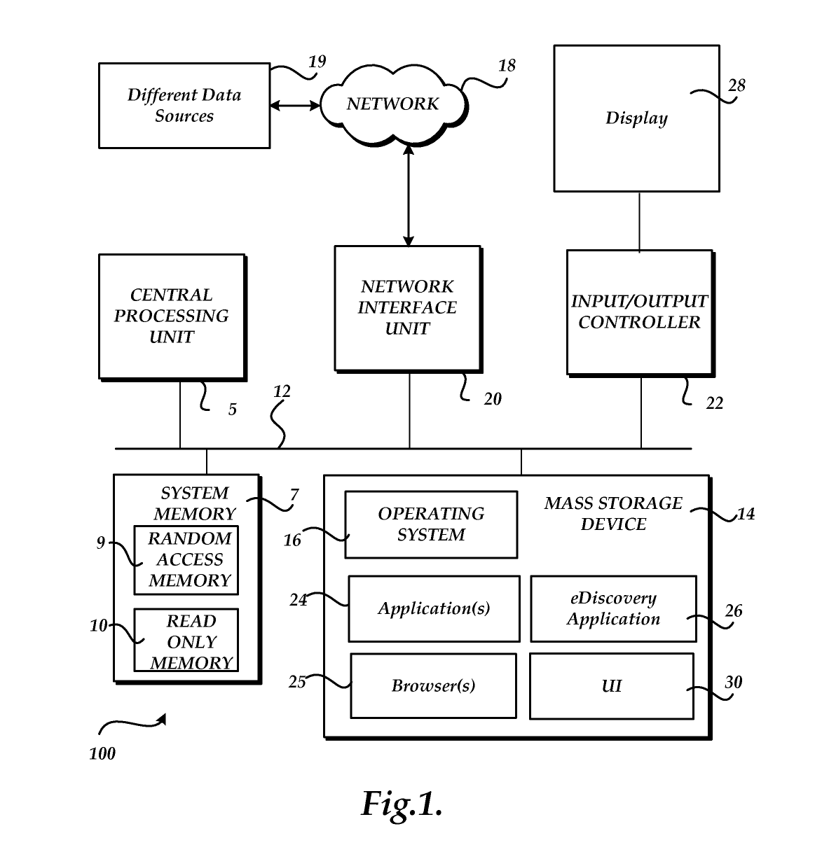

Referring now to the drawings, in which like numerals represent like elements, various embodiments will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer architecture for a computer 100 utilized in the various embodiments will be described. The computer architecture shown in FIG. 1 may be configured as a server computing device, a desktop computing device, a mobile computing device (e.g. smartphone, notebook, tablet . . . ) and includes a central processing unit 5 (“CPU”), a system memory 7, including a random access memory 9 (“RAM”) and a read-only memory (“ROM”) 10, and a system bus 12 that couples the memory to the central processing unit (“CPU”) 5.

A basic input/output system containing the basic routines that help to transfer information between elements within the computer, such as during startup, is stored in the ROM 10. The computer 100 further includes a mass storage device 14 for storing an operating system 16, application(s) 24, and other program modules, such as Web browser 25, eDiscovery application 26 and UI 30.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, Erasable Programmable Read Only Memory (“EPROM”), Electrically Erasable Programmable Read Only Memory (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

According to various embodiments, computer 100 may operate in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, such as a touch input device. The touch input device may utilize any technology that allows single/multi-touch input to be recognized (touching/non-touching). For example, the technologies may include, but are not limited to: heat, finger pressure, high capture rate cameras, infrared light, optic capture, tuned electromagnetic induction, ultrasonic receivers, transducer microphones, laser rangefinders, shadow capture, and the like. According to an embodiment, the touch input device may be configured to detect near-touches (i.e. within some distance of the touch input device but not physically touching the touch input device). The touch input device may also act as a display 28. The input/output controller 22 may also provide output to one or more display screens, a printer, or other type of output device.

A camera and/or some other sensing device may be operative to record one or more users and capture motions and/or gestures made by users of a computing device. Sensing device may be further operative to capture spoken words, such as by a microphone and/or capture other inputs from a user such as by a keyboard and/or mouse (not pictured). The sensing device may comprise any motion detection device capable of detecting the movement of a user. For example, a camera may comprise a MICROSOFT KINECT® motion capture device comprising a plurality of cameras and a plurality of microphones.

Embodiments of the invention may be practiced via a system-on-a-chip (SOC) where each or many of the components/processes illustrated in the FIGURES may be integrated onto a single integrated circuit. Such a SOC device may include one or more processing units, graphics units, communications units, system virtualization units and various application functionality all of which are integrated (or “burned”) onto the chip substrate as a single integrated circuit. When operating via a SOC, all/some of the functionality, described herein, can be integrated with other components of the computing device/system 100 on the single integrated circuit (chip).

As mentioned briefly above, a number of program modules and data files may be stored in the mass storage device 14 and RAM 9 of the computer 100, including an operating system 16 suitable for controlling the operation of a networked computer, such as the WINDOWS SERVER®, WINDOWS 7® operating systems from MICROSOFT CORPORATION of Redmond, Wash.

The mass storage device 14 and RAM 9 may also store one or more program modules. In particular, the mass storage device 14 and the RAM 9 may store one or more applications 24, such as an electronic discovery (eDiscovery) application, messaging applications, productivity applications, and the like. Computer 100 may store one or more Web browsers 25. The Web browser 25 is operative to request, receive, render, and provide interactivity with electronic documents, such as a Web page. For example, a user may access a cloud based eDiscovery service using a browser.

eDiscovery application 26 is configured to assist in managing an electronic discovery process across different electronic data sources. The eDiscovery application assists in managing: authentication support for the different data sources; accessing the different data sources 19; placing holds on content across the different data sources; searching and filtering content across the different data sources; gathering data across the data sources; and the like. The eDiscovery application may be configured as an application on premises (as shown), as a cloud based service and/or a combination of a cloud based service and an application on premises. Additional details regarding the operation of the eDiscovery application 26 will be provided below.

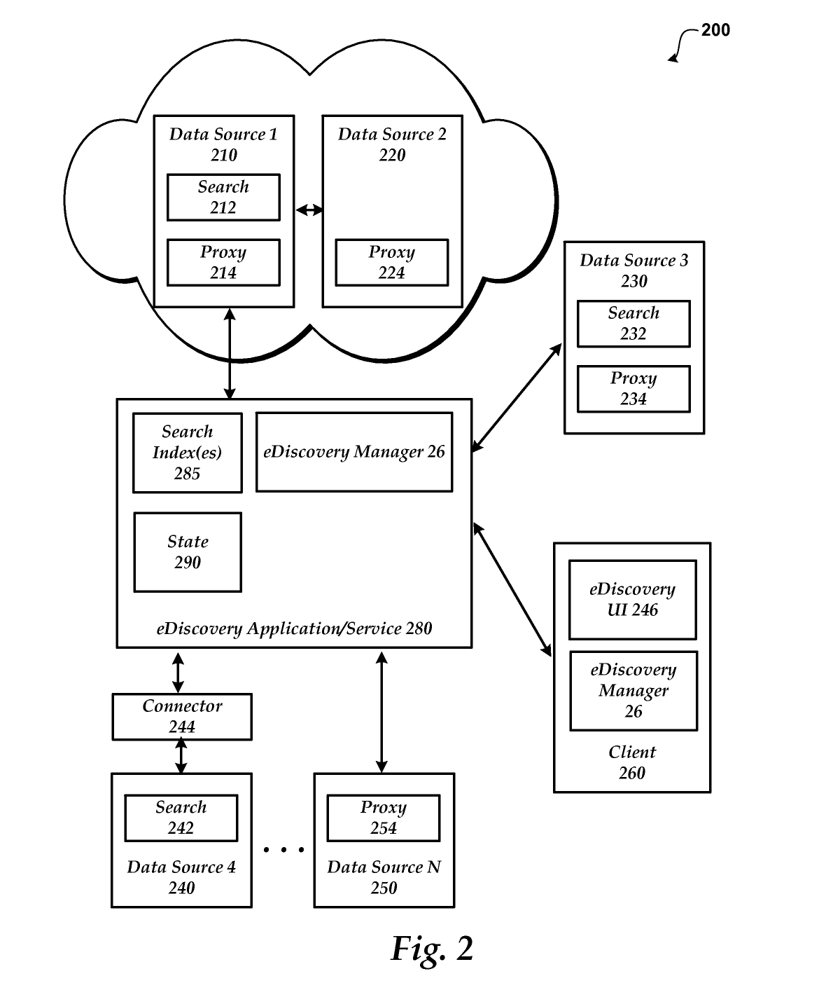

FIG. 2 illustrates an exemplary eDiscovery system. As illustrated, system 200 includes data sources 1-N (data source 1 (210), data source 2 (220), data source 3 (230), data source 4 (240), data source N (250), an client 260.

Many different data sources may be identified as being relevant to an eDiscovery process. Some of the identified data sources may be smarter (e.g. a MICROSOFT SHAREPOINT data source) as compared to other data sources (e.g. a file store data source). Some of the data may be stored in stand-alone data sources, some content may be stored in farms that span a large area (e.g. across different countries, networks). The identified data sources may include different types of content. For example, some data sources may store: electronic messages, documents, notes, metadata, and the like. The data sources may be federated data sources and/or non-federated data sources.

As illustrated, eDiscovery application 280 comprises eDiscovery manager 26, search index(es) 285, state 290. The eDiscovery application 280 may comprise more/fewer components. The eDiscovery application 280 may be configured as a cloud based service and/or an on premises application. For example, the functionality of the eDiscovery application may be accessed through a cloud based service and/or through an on premises application.

The eDiscovery application 280 is coupled to the different data sources using a proxy (e.g. proxy 214, 224, 234, 254) or through a connector (e.g. 244). The proxy/connectors are created/configured for each of the different data sources to utilize the available functionality that is provided by the data source. The eDiscovery application 280 is configured to utilize a default Search Service Application that may be associated with a data source. For example, when the eDiscovery application 280 is deployed in a SHAREPOINT farm or a similar type farm, then it may use the default search service application for the farm. Each different data source may use a different search service and/or not include a search service. As illustrated, data source 1 uses search 212, data source 2 and data source N do not have an associated search service, data source 3 uses search 232, and data source 4 uses search 242.

The proxy/connector is configured to transform commands issued by the eDiscovery application 280 into a form that is understood by the data source and uses the functionality that is provided by the data source. For example, when the data source is one type of database the proxy/connector converts the command into one form and when the data source is a content collaboration service (e.g. MICROSOFT SHAREPOINT) the command is converted to another form. According to an embodiment, when search services are not provided by a data source, eDiscovery application 280 may crawl the data source to create an index (e.g. search index 285). According to an embodiment, the proxy/connector(s) are developed specifically for the type of data source that is connected to the eDiscovery application.

A user may perform a federated search across the different data sources to identify data of interest. For example, a user that is associated with client 260 may access eDiscovery application 280 using eDiscovery UI 246 and eDiscovery manager 26. A user may perform a command on the identified data from the different data sources. For example, a common command for eDiscovery is the ability to place content on hold. Using the eDiscovery UI 246, a user may initiate a hold to preserve data and may later release/update that hold. The hold command is delivered to the data source to perform the command. The hold command may be performed differently across the different data sources. For example, a file share (e.g. data source 2) may be placed in a hold by changing access controls to the identified data in the data source and/or by exporting the data to another store such that it may be preserved. Some other data sources (e.g. MICROSOFT SHAREPOINT 15, MICROSOFT EXCHANGE 15) may be preserved in-place (e.g. a copy of the data is not created to maintain a current state of the data) whereas other data sources (e.g. a file share, some other document stores) may preserve data by exporting the data to a location such that the current state is maintained. The eDiscovery application 280 uses the available functionality of the data source to perform the operation. In this way, available functionality of a data source is attempted to be utilized when available.

The eDiscovery application 280 is configured to manage authentication for users. The eDiscovery application leverages the authorization mechanisms of the individual data sources and follows industry standard protocols to “authenticate” the current user. Each of the different data sources may have different authentication procedures. An eDiscovery users security group may be created that provides users that are placed in the group access rights to the data from the different data sources. Users may be added/removed from the group as required. According to an embodiment, the following permissions levels may be used: an Administrators permissions to modify eDiscovery user permissions and possibly other SEARCH SERVICE APPLICATION actions; Preservation Initiation and Release permissions to initiate and release preservation actions; Full Search permissions to conduct searches; Limited Search permissions to validate locations and mailboxes, see the name and size, but limit the items inside.

The eDiscovery application 280 is configured to maintain state information (state 290) for different eDiscovery processes. The state information may comprise transient state information and stored state information. For example, state information 290 may provide state information for each of the different eDiscovery processes being managed by the eDiscovery application 280 for one or more users. The state information may include information such as case information, hold information, site information, federation information, source information, action information, command information, query information, error information, status information, modification times, and the like.

The eDiscovery application 280 may issue different commands to the different data sources that may each process the command differently. Some exemplary commands, include but are not limited to: hold, release hold, update hold, get status, perform query, clear command, export content, display available data sources, and the like. Execution of the commands may be scheduled based on specifications of the different data sources on which the command is to be performed. For example, one data source may desire commands to be queued and the submitted whereas other data sources may desire to receive commands immediately. The proxy/connector that is associated with each of the different data sources may be configured to assist in managing the execution of the commands

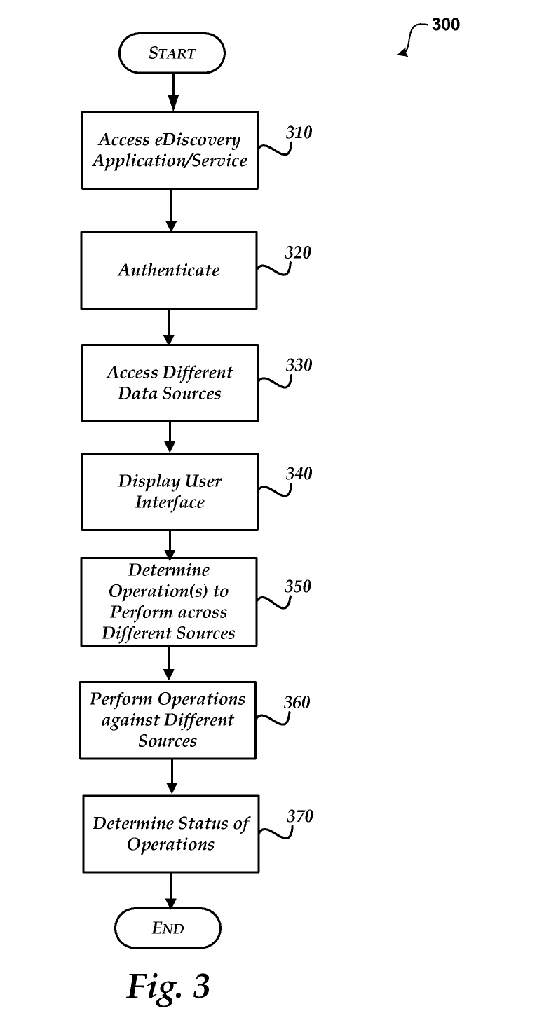

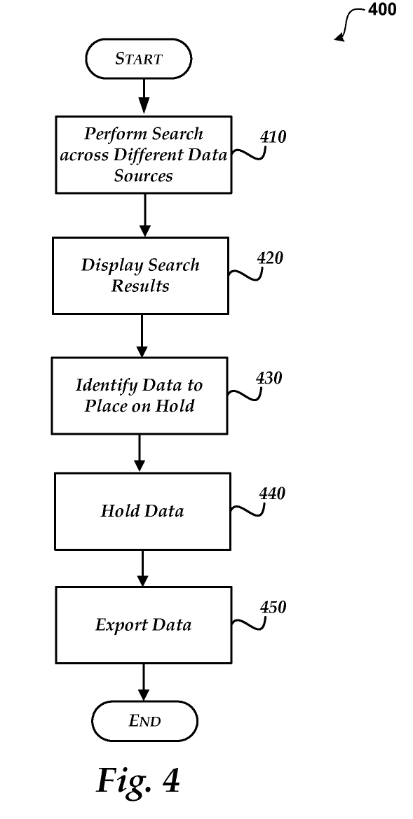

FIGS. 3 and 4 show illustrative processes for managing an eDiscovery process from a central interface. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

FIG. 3 shows a process for managing an eDiscovery process from a central interface that spans different data sources.

After a start operation, the process 300 flows to operation 310, where an eDiscovery application is started. The eDiscovery application may be configured as an application, a cloud based service and/or a combination of a cloud based service and an application. A user may access the eDiscovery application from a user interface using a client computing device. For example, the user may launch a web browser to access the eDiscovery application, launch a client eDiscovery application, and/or launch a client eDiscovery application that communicates with the eDiscovery application provided by a cloud based service.

Moving to operation 320, user is authenticated. According to an embodiment, the authentication information is used to determine access levels that are available to the user at the different data sources that are available.

Flowing to operation 330, different data sources that are available are accessed. Each of the different data sources may have different authentication procedures that may be managed through the eDiscovery application. For example, a trust relationship may be established between the eDiscovery application and the different data sources (e.g. tokens/certificates).

Transitioning to operation 340, a user interface is displayed to assist a user in managing an eDiscovery process. The UI may display many types of interfaces that allow a user to perform operations relating to the eDiscovery process. For example, the UI may provide a selection interface to select the different data sources, perform a search across the different data sources, perform a command (e.g. hold, export, status, and the like), and determine a status of an eDiscovery process.

Moving to operation 350, a determination is made as to what operations are to be performed across the different data sources. For example, data may be identified by a search in two of three different data sources that is to be placed on a hold.

Flowing to operation 360, the determined operations are performed. The operations are performed based on the functionality that is provided the data source. For example, each proxy or connector may leverage the available functionality of the data source.

Transitioning to operation 370, the status of the operations may be determined. For example, it may take a period of time to perform a command and hence updated statuses are available asynchronously.

The process then moves to an end operation and returns to processing other actions.

FIG. 4 shows a process for searching and identifying data across different data sources and placing a hold on the identified data.

After a start operation, the process 400 flows to operation 410, where a search is performed across the different data sources. Each of the data sources may have different search capabilities. For example, a database data source may have a first set of search capabilities, a content collaboration data source (e.g. MICROSOFT SHAREPOINT) may have a second set of search capabilities, a messaging service (e.g. MICROSOFT EXCHANGE) may have a third set of search capabilities, a file store data source (e.g. a file system) may have a fourth set of search capabilities. When performing the search across the different data sources, the data sources perform the queries using their available search capabilities. For sources that are directly indexed by the central search system, queries are executed in the central search system itself. For sources that are not indexed by the central search system, query commands are passed through connectors and the sources do the search themselves. As a result, some data sources provide better search capabilities then other data sources. A proxy/connector that is located between the eDiscovery application and the data source transforms the search query into a form that is understandable by the data source to which it is coupled.

Moving to operation 420, the search results are displayed. The search results may be presented in different ways. For example, the search results may be aggregated, the search results may be displayed by data source, the search results may be sorted on type and/or some other characteristic, and the like.

Flowing to operation 430, data is identified to be placed on hold. The data that is determined to be placed on hold may be stored by one or more of the data sources. According to an embodiment, a user selects data from the search results to place on hold. The user may also enter other characteristics to determine data to place on hold. For example, a user may identify a range of dates to determine the data to place on hold.

Transitioning to operation 440, the commands to place the data on hold are issued to the different data source(s). The hold command is delivered to the data source to perform the command. The hold command may be performed differently across the different data sources. For example, a messaging data source may place a hold on messages in-place whereas a file store data source may export data to be placed in a hold. The eDiscovery application uses the functionality of the data source to manage the hold operation. In this way, available functionality of a data source is attempted to be utilized when available.

Flowing to operation 450, a command to export data is performed. The data may be exported to one or more other locations from the data sources. As with other commands/operations that are issued by the eDiscovery application, the functionality of the data source is utilized. For example, a messaging data source may export the data using a first file format whereas another data source uses a second file format.

The process then moves to an end operation and returns to processing other actions.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method of electronic discovery across different data sources, comprising:
determining different data sources to include in an electronic discovery process;
determining an operation to perform on data that is included in the different data sources; and
performing the operation on the identified data across the different source using mechanisms provided by the data source, wherein at least a portion of the different data sources are actively servicing requests relating to the data stored therein.

2. The method of claim 1, further comprising performing a search across the different data stores using provided search capabilities when available from each of the different data stores.

3. The method of claim 1, wherein determining the operation to perform comprises determining that the operation is a hold command that when performed places a hold on the identified data that preserves the data in a current state and preserving the identified data in place within the data source when the data source allows in place preservation.

4. The method of claim 2, further comprising automatically exporting the data for preservation when the data source does not allow in place preservation of the identified data.

5. The method of claim 1, displaying a user interface that allows selection of the different data sources, wherein the different data sources comprise electronic mailboxes, file stores, and repositories having associated search services.

6. The method of claim 1, further comprising performing a federated authentication of a user that authenticates the user for performing operations on the different data sources, wherein at least a portion of the different data sources use different authentication procedures.

7. The method of claim 1, wherein determining the command comprises determining when the command is an option to export selected data from the different data sources.

8. The method of claim 1, further comprising determining a status of a performance of the command and updating a user interface display with the status.

9. The method of claim 1, wherein the different data sources include federated data sources and non-federated data sources and wherein the electronic discovery process is performed by at least one of: a cloud based service; an on premises process and a combination of the cloud based service and the on premises process.

10. A computer-readable medium having computer-executable instructions for discovery across live disparate data stores, comprising:
performing a search across different data stores using provided search capabilities when available from each of the different data stores;
identifying data from results of the search;
determining an operation to perform on the identified data, wherein the operation is selected from options comprising at least: a hold; a release of a hold, an update of a hold; and an export of data; and
performing the operation on the identified data across the different source using mechanisms provided by the data source, wherein at least a portion of the different data sources are actively servicing requests relating to the data stored therein.

11. The computer-readable medium of claim 10, wherein when the operation is a hold command the identified data is preserved in a current state and is stored in-place or is exported depending on the data store.

12. The computer-readable medium of claim 10, displaying a user interface that allows selection of the different data sources, wherein the different data sources comprise electronic mailboxes, file stores, and repositories having associated search services.

13. The computer-readable medium of claim 10, further comprising performing a federated authentication of a user that authenticates the user for performing operations on the different data sources, wherein at least a portion of the different data sources use different authentication procedures.

14. The computer-readable medium of claim 10, further comprising determining a status of a performance of the command and updating a user interface display with the status.

15. The computer-readable medium of claim 10, wherein the different data sources include federated data sources and non-federated data sources.

16. A system for discovery across live disparate data stores, comprising:
a network connection that is coupled to different data sources;
a processor and a computer-readable medium;
an operating environment stored on the computer-readable medium and executing on the processor; and
an eDiscovery manager operating under the control of the operating environment and operative to:
perform a search across the different data stores using provided search capabilities when available from each of the different data stores;
identify data from results of the search;
determine an operation to perform on the identified data, wherein the operation is selected from options comprising at least: a hold; a release of a hold, an update of a hold; and
perform the operation on the identified data across the different source using mechanisms provided by the data source,
wherein at least a portion of the different data sources are actively servicing requests relating to the data stored therein.

17. The system of claim 16, wherein when the operation is a hold command the identified data is preserved in a current state and is stored in-place or is exported depending on the data store.

18. The system of claim 16, displaying a user interface that allows selection of the different data sources, wherein the different data sources comprise electronic mailboxes, file stores, and repositories having associated search services.

19. The system of claim 16, further comprising performing a federated authentication of a user that authenticates the user for performing operations on the different data sources, wherein at least a portion of the different data sources use different authentication procedures.

20. The system of claim 16, further comprising determining a status of a performance of the command and updating a user interface display with the status.
